(19) United States
(12) Patent Application Publication
(10) Pub. No.: US 2024/0253618 A1
(43) Pub. Date: Aug. 1, 2024

(54) SPEED LIMIT CONTROL APPARATUS

(71) Applicant: TOYOTA JIDOSHA KABUSHIKI KAISHA, Aichi (JP)

(72) Inventors: Toshihiro TAKAGI, Nisshin-shi (JP); Kazuya SUZUMURA, Hamamatsu-shi (JP)

(21) Appl. No.: 18/419,553

(22) Filed: Jan. 23, 2024

(30) Foreign Application Priority Data
Jan. 26, 2023 (JP) 2023-010026

(51) Int. Cl. B60W 30/09; B60W 30/095

(52) U.S. Cl. CPC B60W 30/09; B60W 30/095; B60W 2554/20; B60W 2720/10

(57) ABSTRACT

A speed limit control apparatus comprises a sensor configured to detect an object, and a controller configured to execute a vehicle limit control for limiting a speed of a vehicle an upper limit speed or less until the vehicle reaches a target space. The controller divides a target path into a high possibility area where an entry possibility that a moving object enters the target path is high and a low possibility area where the entry possibility is low, based on whether or not the area of the target path is surrounded by inhibiting objects that inhibits the moving object from entering the target path. When the vehicle travels in the low possibility area, the controller sets the upper limit speed higher than the upper limit speed that is set when the vehicle travels in the high possibility area.

### TECHNICAL FIELD

The present disclosure relates to a speed limit control apparatus configured to execute a speed limit control for limiting a speed of a vehicle to an upper limit speed or less until the vehicle reaches a target space.

### BACKGROUND

ISO20900(Partially automated Parking Systems: PAPS) and ISO16787(Assisted Parking Systems: APS) define a parking control for parking a vehicle. There has been known a leaving control to make the vehicle leave from a parking space.

There has been known a speed limit control apparatus for setting an upper limit speed of a speed (a vehicle speed) of the vehicle until the vehicle reaches a target parking space or a target leaving space during executing the parking control or the leaving control. Hereinafter, when the target parking space and the target leaving space are not distinguished from each other, each of these spaces is referred to as a “target space”.

For example, the speed limit control apparatus (hereinafter, referred to as a “conventional apparatus”) disclosed in Japanese Patent Application Laid-Open No. 2006-335239 detects an object in a direction which is set in accordance with a target path to the target parking space. The longer a distance between the object and the vehicle, the upper limit speed is set to be higher by the conventional apparatus.

According to the conventional device, the vehicle speed is low when the distance between the object and the vehicle is short, because the contact between the vehicle and the object is predicted when the distance is short. Furthermore, according to the conventional device, the vehicle speed is high when the distance is long.

Accordingly, a travel time to the target space can be shortened when the distance is long, and an inadvertent approach to the object can be suppressed when the distance is short.

### SUMMARY

When an inhibiting object such as a wall, a guardrail, or a track is present in each of a left area and a right area of a target path (that is, when the target path is surrounded by the inhibiting objects), a possibility that a moving object enters the target path is reduced. The inhibiting object is an object that inhibits the moving object from entering the target path. In such a case, a possibility that the moving object enters the target path to contact the vehicle is low. Therefore, it is desirable to set the upper limit speed to be high in order to shorten the travel time. However, in such a case, since the distance between the vehicle and the inhibiting object is likely to be short, the conventional apparatus tends to set the upper limit speed low.

The present disclosure has been made to address the above-described problem. That is, it is an object of the present disclosure to provide a speed limit control device that can reduce a possibility that the vehicle contacts the moving object and shorten the travel time to the target space.

A speed limit control apparatus (hereinafter, referred to as a “present disclosure apparatus”) according to the present disclosure comprises:
a sensor (22A to 22D, 24A to 24D, 28A and 28B, 30A and 30B) configured to detect an object that is present in a predetermined area including a left side area and a right side area with respect to a travel direction of a vehicle; and
a controller (20) configured to execute a vehicle limit control for limiting a speed of the vehicle to an upper limit speed or less until the vehicle reaches a target space.

The controller is configured to:
divide an area of a target path that the vehicle follows until the vehicle reaches the target space into a high possibility area and a low possibility area, based on whether or not the area of the target path is surrounded by inhibiting objects that inhibit a moving object from entering the target path (step 435 and step 475),
   the high possibility area is an area where an entry possibility that the moving object enters the target path is high,
   the low possibility area is an area where the entry possibility is low; and
when the vehicle travels in the low possibility area, set the upper limit speed (Vsg2) higher than the upper limit speed (Vsg1) that is set when the vehicle travels in the high possibility area.

The possibility that the moving object enters the target path which is surrounded by the inhibiting objects is lower than the possibility that the moving object enters the target path which is not surrounded by the inhibiting objects. The present disclosure apparatus sets the upper limit speed in the low possibility area higher than the upper limit speed in the high possibility area. The low possibility area is an area where the target path is surrounded by the inhibiting objects. The high possibility area is an area where the target path is not surrounded by the inhibiting objects. Accordingly, the present disclosure apparatus can reduce the possibility that the vehicle contacts the moving object and shorten the travel time to the target space.

### BRIEF DESCRIPTION OF THE DRAWINGS

FIG. 1 is a schematic system diagram of a speed limit control apparatus according to the present disclosure.

FIG. 2 is a drawing for describing an operation of the speed limit control apparatus.

FIG. 3 is a flowchart illustrating a target space setting routine executed by a CPU of the speed limit control apparatus.

FIG. 4A is a flowchart illustrating a part of a travel control routine executed by the CPU of the speed limit control apparatus.

FIG. 4B is a flowchart illustrating the rest of the travel control routine executed by the CPU of the speed limit control apparatus.

### DETAILED DESCRIPTION

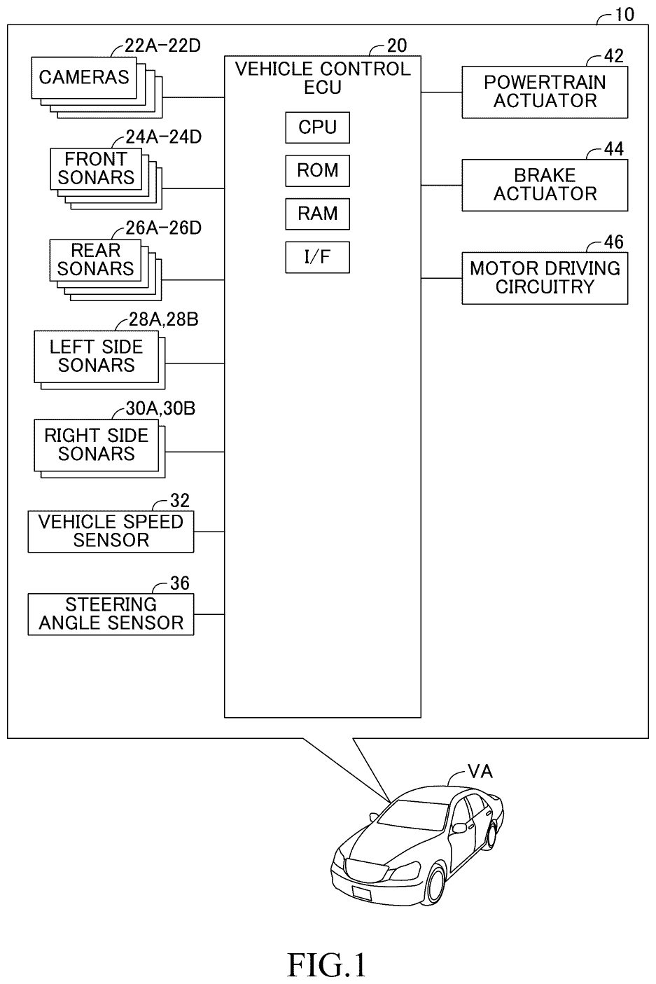

As shown in FIG. 1, a speed limit control apparatus (hereinafter referred to as a “present apparatus 10”) according to an embodiment of the present disclosure is applied to a vehicle VA and comprises component elements shown in FIG. 1.

A vehicle control ECU20 is an ECU that executes a speed limit control, and is hereinafter referred to as an “ECU20”. The speed limit control is a control for limiting a speed (a vehicle speed) Vs of the vehicle VA to an upper limit speed Vlmt or less until the vehicle VA reaches a target space.

In the present specification, an “ECU” is an electronic control unit/device including a microcomputer as a main component. The ECU may also be referred to as a “control unit”, a “controller”, or a “computer”. The microcomputer includes a CPU (processor), a ROM, a RAM, and an interface (I/F). Some or all of the ECU20 and ECUs described later may be integrated into a single ECU.

Cameras 22A to 22D are a front camera, a left camera, a right camera and a rear camera, respectively. The front camera, the left camera, the right camera and the rear camera respectively capture a front area, a left area, a right area and a rear area of the vehicle VA to acquire a front image, a left image, a right image and a rear image. When there is no need to distinguish among the cameras 22A to 22D, each of them is referred to as a “camera 22”.

Each of sonars included in the present apparatus 10 will be described below. The sonar transmits ultrasonic waves and receives the ultrasonic waves reflected by an object. The sonar specifies a distance to the object based on time from transmitting the ultrasonic waves to receiving the ultrasonic waves, and transmits sonar object information including the distance to the ECU20.

Front sonars 24A to 24D are disposed in a front bumper of the vehicle VA, rear sonars 26A to 26D are disposed in a rear bumper of the vehicle VA, left side sonars 28A and 28 are disposed in a left side of the vehicle VA, and right side sonars 30A and 30B are disposed in a right side of the vehicle VA.

Each of the front sonars 24A to 24D acquires the distance to the object in the front area of the vehicle VA, each of the rear sonars 26A to 26D acquires the distance to the object in the rear area of the vehicle VA, each of the left side sonars 28A and 28B acquires the distance to the object in the left area of the vehicle VA, and each of the right side sonar 30A and 30B acquires the distance to the object in the right area of the vehicle VA.

A vehicle speed sensor 32 detects a speed of the vehicle VA (a vehicle speed Vs). A steering angle sensor 36 detects a steering angle θ of the vehicle VA. The ECU20 receives a detected value from each of these sensors.

A powertrain actuator 42 changes a driving force generated by a driving device (for example, an internal combustion engine and/or an electric motor) of the vehicle VA. A brake actuator 44 controls a braking force applied to the vehicle VA. The ECU20 drives a steering assist motor (not shown) by controlling a motor driving circuitry 46 so as to change the steering angle of the vehicle VA. A display device (not shown) displays a landscape image of a traveling direction of the vehicle VA, an overhead image of the vehicle VA and a surrounding area of the vehicle VA, and the like.

### (Operation)

The ECU20 can execute at least one of a parking control and a leaving control. The parking control is a control that performs at least a steering operation on behalf of a driver in order to park the vehicle VA in a target parking space. The leaving control is a control that performs at least the steering operation on behalf of the driver in order to leave the vehicle VA out of a parking space so as to move the vehicle VA to a target leaving space. When the target parking space and the target leaving space are not distinguished from each other, each of them is referred to as a “target space SP”. The ECU20 executes a speed limit control when either the parking control or the leaving control is executed. The speed limit control is a control for limiting the vehicle speed Vs to the upper limit speed Vlmt or less until the vehicle VA reaches the target space SP.

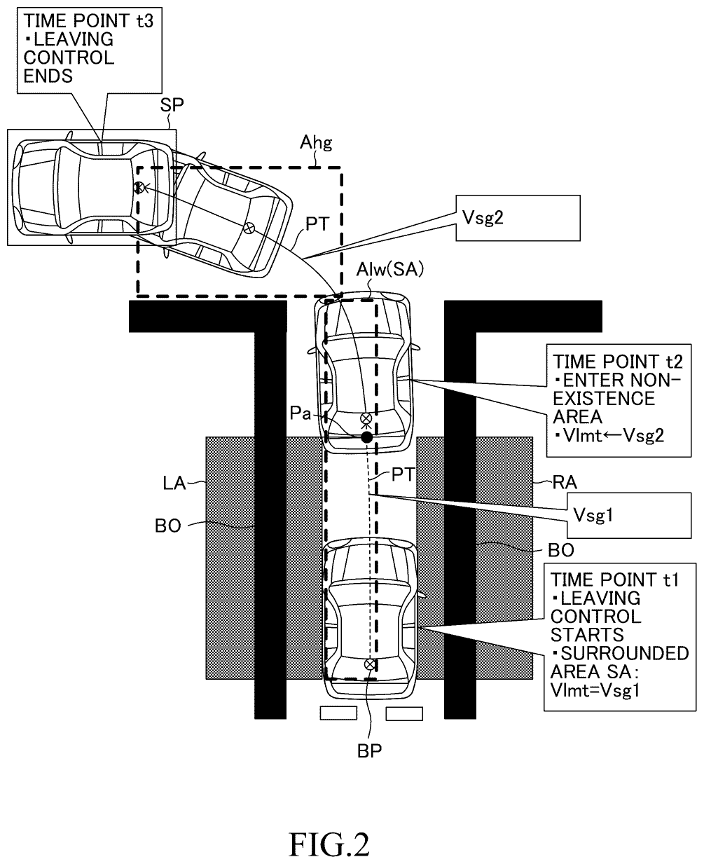

The ECU20 acquires the images from the cameras 22 and the sonar object information from the sonars when either the parking control or the delivery control is executed. The ECU20 specifies a position of the object with respect to the vehicle VA based on the images and the sonar object information. The ECU20 generates, based on the position of the object with respect to the vehicle VA, a target path PT (see FIG. 2) that the vehicle VA follows until the vehicle VA reaches the target space SP such that the vehicle VA does not contact the object.

The ECU20 divides the target path PT into a high possibility area Ahg and a low possibility area Alw, based on whether both a left area and a right area with respect to the traveling direction of the target path PT are surrounded by inhibiting objects BO. The inhibiting object BO is a stationary object that inhibits a moving object from entering an area of the target path PT. For example, the inhibiting object BO is a wall, a guardrail, and a truck. A possibility that the moving object (such as a pedestrian or another vehicle) enters the target path PT in the high possibility area Ahg is higher than that in the low possibility area Alw. The ECU20 sets the upper limit speed Vlmt in the low probability area Alw higher than the upper limit velocity Vlmt in the high probability area Ahg.

Since the upper limit velocity Vlmt in the low possibility area Alw is set to be higher than that in the high possibility area Ahg, the possibility that the vehicle VA contacts the moving object can be reduced, and the travel time to the target space SP can be shortened.

A method for dividing the target path PT into the high possibility area Ahg and the low possibility area Alw will be described.

The ECU20 specifies an area of the target path PT surrounded by the inhibiting objects BO (surrounded area SA) as the low possibility area Alw. The ECU20 specifies an area of the target path PT in which a stationary object that is not the inhibiting object BO is present on at least one of the left side and the right side of the target path PT (non-surrounded area NSA) as the high possibility area Ahg.

Furthermore, the ECU20 specifies an area of the target path PT in which no object is present on both the left side and the right side of the target path PT (non-existence area NA) as the low possibility area Alw. It should be noted that the ECU20 determines that the vehicle VA is traveling in the high possibility area SA from an entry time point to a satisfaction time point. The entry time point is a time point at which the vehicle VA enters the non-existence area NA from the surrounded area SA. The satisfaction time point is a time point at which a predetermined release condition (which will be described later) is satisfied.

### (Operation Example)

An operation example of the present device 10 will be described with reference to FIG. 2.

At a time point t1 shown in FIG. 2, the ECU20 starts the leaving control. Specifically, the ECU20 recognizes the object based on the images and the sonar object information, and generates the target path PT to the target leaving space PS.

Furthermore, the ECU20 detects the inhibiting objects BO in both a left area LA and a right area RA. The left area LA is located in a left side with respect to the traveling direction of the vehicle VA. The right area RA is located in a right side with respect to the traveling direction of the vehicle VA. For this reason, the ECU20 specifies an area from a reference point BP of the vehicle VA at the time point t1 to a point Pa on the target path PT as the “surrounded area SA (i.e., low possibility area Alw) which is surrounded by the inhibiting objects BO”. The reference point BP is set in advance at a midpoint between a left rear wheel and a right rear wheel of the vehicle VA. At the time point t1, the ECU20 determines that the vehicle VA is traveling in the low possibility area Alw and sets the upper limit velocity Vlmt to “Vsg1” for the low possibility area Alw.

Every time a predetermined time elapses while the leaving control or the parking control is being executed, the ECU20 generates the target path PT, and sets the upper limit speed Vlmt based on whether the vehicle travels in the low possibility area Alw or the high possibility area Ahg.

At the time point t2, a part of a vehicle body of the vehicle VA is included in the non-existence area NA. At the time point t2, the ECU20 determines that the vehicle VA enters the non-existence area NA from the surrounded area SA. That is, the time point t2 is the entry time point. Therefore, the ECU20 determines that the vehicle VA is traveling in the high possibility area Ahg from the time point t2 to the satisfaction time point at which the predetermined release condition is satisfied. Accordingly, the ECU20 sets the upper limit speed Vlmt to “Vsg2” for the high possibility area Ahg. Vsg2 is set in advance to be smaller than Vsg1.

When the vehicle VA enters the non-existence area NA from the surrounded area SA, it is highly likely that the inhibiting object BO shields (blocks) a detection area of at least one of sensors such as the cameras 22 and the sonars. Therefore, it is highly likely that the sensors cannot detect the object present in the non-existence area NA. The ECU20 determines that the vehicle is traveling in the high possibility area Ahg from the entry point to the satisfaction time point. Accordingly, it is possible to reduce a possibility that the vehicle VA contacts an object present in the non-existence area NA which is not detected by the sensors.

The ECU20 determines that the release condition is satisfied when a travel distance D from the entry time point t2 becomes equal to or longer than a predetermined threshold distance Dth. The ECU20 sets the upper limit speed Vlmt to “Vsg1” if the vehicle VA travels in the low possibility area Alw when it is determined that the release condition is satisfied, and sets the upper limit speed Vlmt to “Vsg2” if the vehicle VA travels in the high possibility area Ahg when it is determined that the release condition is satisfied.

In the example shown in FIG. 2, the vehicle VA reaches the target leaving space PS so that the leaving control ends at the time point t3 before the release condition is satisfied.

As described above, in a period from the time point t1 to the time point t2, the upper limit speed Vlmt is set to “Vsg1” because the vehicle VA is traveling in the low possibility area Alw. In the period from the time point t2 to the time point t3, the upper limit speed Vlmt is set to “Vsg2” because the vehicle VA is traveling in the high possibility area Ahg.

### (Specific Operation)

### <Target Space Setting Routine>

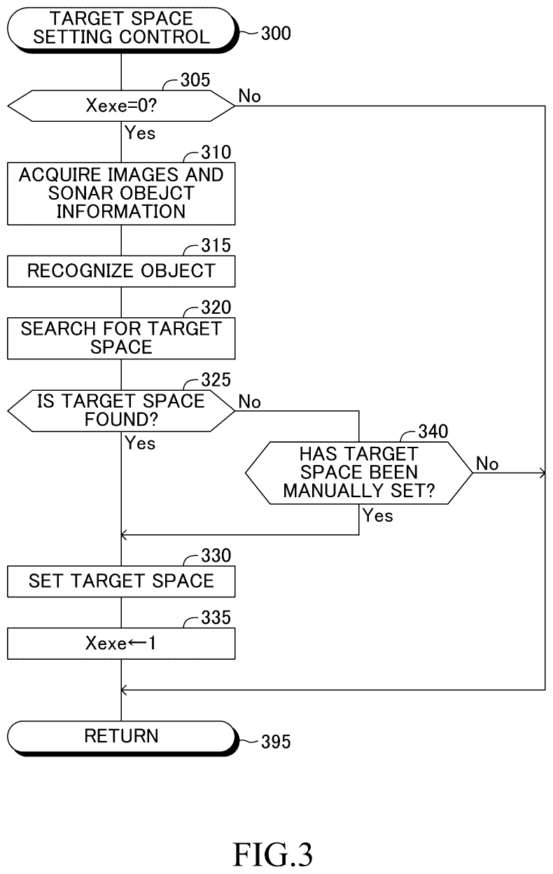

The CPU of the ECU20 executes a routine shown in a flowchart in FIG. 3 when the driver operates a parking button (not shown) or a leaving button (not shown).

When the driver performs the above-described button operation, the CPU starts a process from step 300 of FIG. 3, and the process proceeds to step 305. In step 305, the CPU determines whether or not an execution flag Xexe is “0”.

The execution flag Xexe is set to “1” when a travel control is executed, and is set to “0” when the vehicle VA reaches the target space SP. The CPU executes the parking control as the travel control when the driver operates the parking button, and executes the leaving control as the travel control when the driver operates the leaving button.

When the execution flag Xexe is “0”, the CPU makes a “Yes” determination in step 305, and executes steps 310 to 325.

Step 310: The CPU acquires the images from the cameras 22 and the sonar object information from the sonars.

Step 315: The CPU recognizes the object by specifying the position of the object with respect to the vehicle VA based on the images and the sonar object information.

Step 320: The CPU searches for the target space SP where the vehicle VA can stop based on the position of the object.

Step 325: The CPU determines whether or not the search for the target space SP has succeeded.

When the search for the target space SP has succeeded, the CPU makes a “Yes” determination in step 325 and executes step 330 and step 335.

Step 330: The CPU sets the searched target space SP to the target space SP used in the travel control.

Step 335: The CPU sets the execution flag Xexe to “1”.

Thereafter, the process proceeds to step 395, and the CPU terminates the present routine tentatively.

When the search for the target space SP has failed, the CPU makes a “No” determination in step 325, and the process proceeds to step 340. In step 340, the CPU determines whether or not the target space SP has been manually set.

When the target space SP has been manually set, the CPU makes a “Yes” determination in step 340, and the process proceeds to step 330. On the other hand, when the target space SP has not been manually set, the CPU makes a “No” determination in step 340, and the process proceeds to step 395. In step 395, the CPU terminates the present routine tentatively.

### <Driving Control Routine>

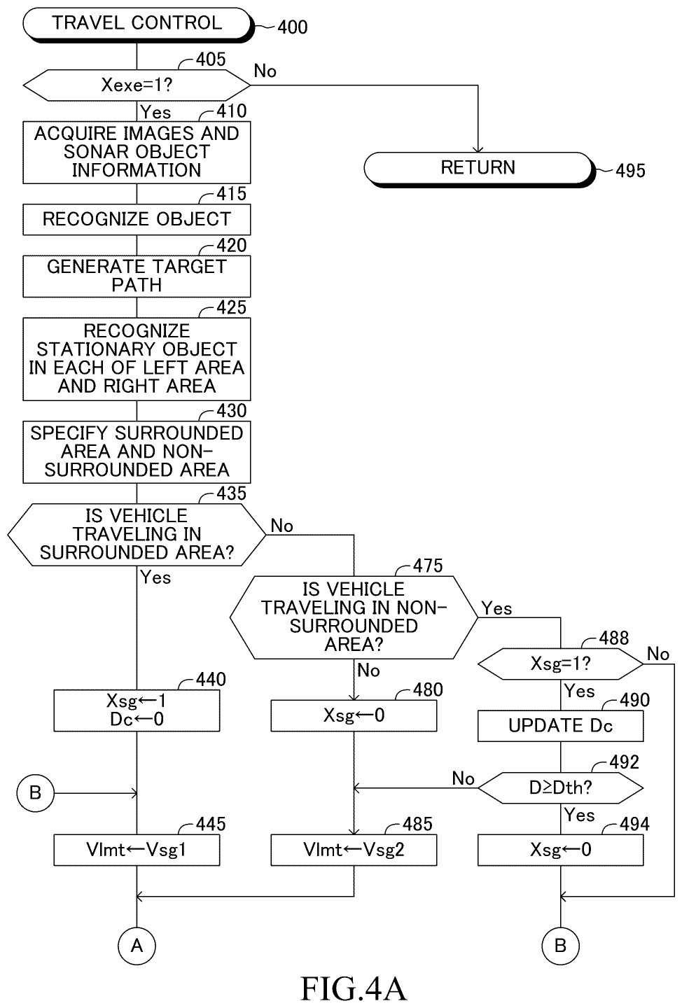

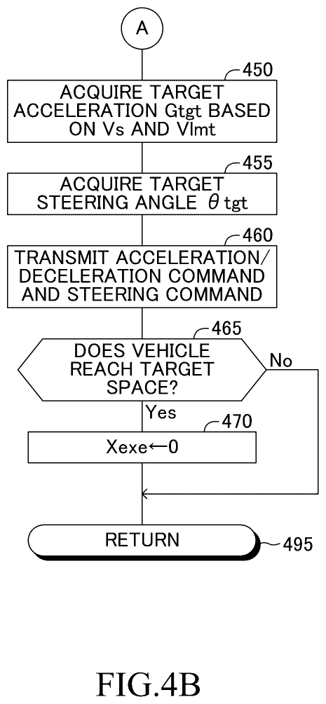

The CPU executes a routine shown in a flowchart in FIG. 4A and FIG. 4B, every time a predetermined time elapses.

When an appropriate time point comes, the CPU starts a process at step 400 of FIG. 4A, and the process proceeds to step 405. In step 405, the CPU determines whether or not the execution flag Xexe is “1”.

When the execution flag Xexe is “0”, the CPU makes a “No” determination in step 405, and the process proceeds to step 495. In step 495, the CPU terminates the present routine tentatively.

When the execution flag Xexe is “1”, the CPU makes a “Yes” determination in step 405 and executes steps 410 to 435. Steps 410 and 415 are the same process as steps 310 and 315 shown in FIG. 3, respectively, and thus description thereof is omitted. In step 420, the CPU generates the target path PT.

Step 425: The CPU recognizes the stationary object existing in each of the left area LA and the right area RA based on a recognition result in step 415.

Step 430: The CPU determines whether the area of the target path PT is the surrounded area SA, the non-existence area NA, or the non-surrounded area NSA based on the recognition result in step 425.

Specifically, the CPU determines that an area in which the inhibiting object BO is present in each of the left area LA and the right area RA is the surrounded area SA. The CPU determines that an area in which the stationary object is not present in either the left area LA or the right area RA is the non-existence area NA. The CPU determines that an area in which the stationary object that is not the inhibiting object BO is present in at least one of the left area LA and the right area RA is non-surrounded area NSA.

Step 435: The CPU determines whether or not the vehicle VA is traveling in the surrounded area SA. Specifically, when at least a part of the vehicle body of the vehicle VA is included in the surrounded area SA (when the vehicle VA enters the surrounded area SA), the CPU determines that the vehicle VA is traveling in the surrounding area SA.

When the vehicle VA is traveling in the surrounded area SA, the CPU makes a “Yes” determination in step 435 and executes steps 440 and 445.

Step 440: The CPU sets a surround flag Xsg to “1”, and sets a distance counter Dc to “0”.

The surround flag Xsg is set to “1” when the vehicle VA is traveling in the surrounded area SA, and is set to “0” when the release condition is satisfied after the vehicle VA enters the non-existence area NA from the surrounded area SA.

The distance counter Dc is a counter for counting the travel distance of the vehicle VA from the entry time point.

Step 445: The CPU sets the upper limit velocity Vlmt to “Vsg1” for the low possibility area Alw.

Thereafter, the CPU executes steps 450 to 465 shown in FIG. 4B.

The step 450: The CPU acquires a target acceleration Gtgt based on the vehicle speed Vs and the upper limit speed Vlmt.

For example, the CPU acquires the target acceleration Gtgt which is set to a predetermined negative value, when the vehicle speed Vs is higher than the upper limit speed Vlmt. The CPU acquires the target acceleration Gtgt which has a predetermined positive value and makes the vehicle speed Vs coincide with the “target speed Vtgt set to be equal to or lower than the upper limit speed Vlmt”, when the vehicle speed Vs is equal to or lower than the upper limit speed Vlmt.

Step 455: The CPU acquires a target steering angle θtgt such that the reference point BP of the vehicle VA follows the target path PT.

Step 460: The CPU transmits an acceleration/deceleration command including the target acceleration Gtgt to the powertrain actuator 42 and the brake actuator 44, and transmits a steering command including the target steering angle θtgt to the motor drive circuitry 46.

The powertrain actuator 42 controls the driving force of the driving device such that an acceleration G of the vehicle VA coincides with the target acceleration Gtgt. The brake actuator 44 controls the braking force such that the acceleration G of the vehicle VA coincides with the target acceleration Gtgt. An acceleration sensor (not shown) detects the acceleration G. The motor drive circuitry 46 controls the steering angle θ such that the steering angle θ of the vehicle VA coincides with the target steering angle θtgt. A control for controlling the driving force and the braking force such that the acceleration G coincides with the target acceleration Gtgt is referred to as a driving/braking control. A control for limiting the steering angle θ such that the steering angle θ coincides with the target steering angle θtgt is referred to as a steering angle control.

Step 465: The CPU determines whether or not the vehicle VA reaches the target space SP.

For example, the CPU determines that the vehicle VA reaches the target space SP when the travel distance becomes equal to a distance along the target path PT to the target space SP.

When the vehicle VA does not reach the target space SP, the CPU makes a “No” determination in step 465, and the process proceeds to step 495. In step 495, the CPU terminates the present routine tentatively.

When the vehicle VA reaches the target space SP, the CPU makes a “Yes” determination in step 465 and the process proceeds to step 470. In step 470, the CPU sets the execution flag Xexe to “0”. Thereafter, the process proceeds to step 495, and the CPU terminates the present routine tentatively.

On the other hand, in a case where the vehicle VA is not traveling in the surrounded area SA when the process proceeds to step 435 shown in FIG. 4A, the CPU makes a “No” determination in step 435 and the process proceeds to step 475 shown in FIG. 4A. In step 475, the CPU determines whether or not the vehicle VA is traveling in the non-existence area NA.

When the vehicle VA is not traveling in the non-existence area NA, the vehicle VA is traveling in the non-surrounding area NSA. In this case, the CPU makes a “No” determination in step 475 and executes steps 480 and 485.

Step 480: The CPU sets the surround flag Xsg to “0”.

Step 485: The CPU sets the upper limit velocity Vlmt to “Vsg2” for the high possibility area Ahg.

Thereafter, the process proceeds to step 450 shown in FIG. 4B.

On the other hand, in a case where the vehicle VA is traveling in the non-existence area NA when the process proceeds to step 475 shown in FIG. 4A, the CPU makes a “Yes” determination in step 475, and the process proceeds to step 488.

In step 488, the CPU determines whether or not the surround flag Xsg is “1”. When the surround flag Xsg is “1”, the vehicle VA enters the non-existence area NA from the surrounded area SA. In this case, the CPU makes a “Yes” determination in step 488 and executes steps 490 and 492.

Step 490: The CPU updates the distance counter Dc.

Specifically, the CPU registers the travel distance of the vehicle VA from the entry time point in the distance counter Dc. The CPU specifies the travel distance of the vehicle VA based on the vehicle speed Vs and an elapsed time from the entry time point.

Step 492: The CPU determines whether or not the travel distance D represented by the distance counter Dc is equal to or longer than the threshold distance Dth.

When the travel distance D represented by the distance counter Dc is shorter than the threshold distance Dth, the CPU determines that the vehicle VA is traveling in the high possibility area Ahg. In this case, the CPU makes a “No” determination in step 492, and the process proceeds to step 485. In step 485, the CPU sets the upper limit velocity Vlmt to “Vsg2” for the high possibility area Ahg. Thereafter, the process proceeds to step 450 shown in FIG. 4B.

When the travel distance D represented by the distance counter Dc is equal to or longer than the threshold distance Dth, the CPU determines that the vehicle VA is traveling in the low possibility area Alw. In this case, the CPU makes a “Yes” determination in step 492 and the process proceeds to step 494. In step 494, the CPU sets the surround flag Xsg to “0” and the process proceeds to step 445. In step 445, the CPU sets the upper limit velocity Vlmt to “Vsg1” for low possibility area Alw. Thereafter, the process proceeds to step 450 shown in FIG. 4B.

In a case where the surround flag Xsg is “0” when the process proceeds to step 488, the CPU determines that the vehicle VA is traveling in the low possibility area Alw. In this case, the CPU makes a “No” determination in step 488, and the process proceeds to step 445. In step 445, the CPU sets the upper limit velocity Vlmt to “Vsg1” for low possibility area Alw. Thereafter, the process proceeds to step 450 shown in FIG. 4B.

According to the present embodiment, based on whether or not the target path PT is the surrounded area SA surrounded by the inhibiting objects BO, the target path PT is divided into the high possibility area Ahg and the low possibility area Alw. The upper limit velocity Vlmt of when the vehicle VA is traveling in the low possibility area Alw is higher than that of when the vehicle AV is traveling in the high possibility area Ahg. Accordingly, it is possible to reduce the possibility that the vehicle VA contacts the moving object and to shorten the travel time to the target space SP.

Furthermore, according to the present embodiment, the surrounded area SA is specified as the low possibility area Alw, and the non-surrounded area NSA is identified as the high possibility area Ahg. The surrounded area SA is an area in which the target path PT is surrounded by the inhibiting objects BO, and therefore, the moving object is unlikely to enter the target path PT in the surrounded area SA. The non-surrounded area NSA is an area in which the stationary object that is not an inhibiting object BO in at least one area of the left area LA and the right area RA of the target path PT. The sensor may not be able to detect the moving object existing outside the stationary object due to the stationary object, and the moving object may enter the target path PT. Therefore, the target path PT can be divided into the high possibility area Ahg and the low possibility area Alw accurately, based on a possibility that the moving object enters the target path PT.

According to the present embodiment, in principle, the non-existence area NA is specified as the low possibility area Alw. Immediately after the vehicle VA enters the non-existence area NA from the surrounded area SA, the moving object which may exist in the non-existence area NA cannot be detected. Therefore, in the present embodiment, it is determined that the vehicle VA is traveling in the high possibility area SA during a time period from the entry time point when the vehicle VA enters the non-existence area NA to a time point when the release condition is satisfied. Accordingly, since the upper limit velocity Vlmt is set low during the above time period immediately after the vehicle VA enters the non-existence area NA from the surrounded area SA, the possibility that the vehicle VA contacts the moving object can be further reduced.

### (First Modification)

In the above embodiment, the ECU20 recognizes the object based on the images and the sonar object information, but may recognize the object based on at least one of the images and the sonar object information. Therefore, the present device 10 may include at least one of the cameras 22 and the sonars. Instead of the sonars, the present device 10 may include a “remote sensing sensor that transmits some kind of electromagnetic wave and detects the object by receiving the electromagnetic wave reflected by the object”.

The number of the cameras 22 and the number of the sonars included in the device 10 are not limited to an example shown in FIG. 1.

### (Second Modification)

In the above-described embodiment, the ECU20 executes the steering control and the driving/braking control as the travel control, but the ECU 20 only need to execute at least one of the steering control and the driving/braking drive control as the travel control. Even if the ECU20 executes only the steering control as the travel control, the ECU20 transmits the target acceleration Gtgt which is set to the predetermined negative value to the powertrain actuator 42 and the brake actuator 44 when the vehicle speed Vs is higher than the upper limit speed Vlmt.

### (Third Modification)

In the above embodiment, the ECU20 may set the upper limit velocity Vlmt to “Vsg3”, when the ECU 20 determines that the vehicle VA is traveling in the low possibility area Alw based on a determination that the vehicle VA is traveling in the non-existence area NA. This “Vsg3” is set to be higher than “Vsg1”. When the vehicle VA is traveling in the non-existence area NA, the sensor is more likely to be able to reliably detect the moving object than when the vehicle VA is traveling in the surrounded area SA, because there is a possibility that the moving object (for example, a pedestrian) gets over the inhibiting object BO that is present in the surrounded area SA to enter the target path PT even when the vehicle VA is traveling in the surrounded area SA. The sensor may not be able to detect the moving object by being blocked by the inhibiting object BO until the moving object gets over the inhibiting object BO.

The present apparatus 10 may be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). The present apparatus 10 can also be applied to an autonomous control vehicle.

What is claimed is:

1. A speed limit control apparatus comprising:
a sensor configured to detect an object that is present in a predetermined area including a left side area and a right side area with respect to a travel direction of a vehicle; and
a controller configured to execute a vehicle limit control for limiting a speed of the vehicle to an upper limit speed or less until the vehicle reaches a target space;
wherein,
the controller is configured to:
divide an area of a target path that the vehicle follows until the vehicle reaches the target space into a high possibility area and a low possibility area, based on whether or not the area of the target path is surrounded by inhibiting objects that inhibit a moving object from entering the target path,
the high possibility area is an area where an entry possibility that the moving object enters the target path is high,
the low possibility area is an area where the entry possibility is low; and
when the vehicle travels in the low possibility area, set the upper limit speed higher than the upper limit speed that is set when the vehicle travels in the high possibility area.

2. The speed limit control apparatus according to claim 1,
wherein,
the controller is configured to:
determine that an area of the target path that is surrounded by the inhibiting objects is the low possibility area; and
determine that an area of the target path of which an object that is not the inhibiting object is present in at least one of a left side and a right side is the high possibility area.

3. The speed limit control apparatus according to claim 2,
wherein,
the controller is configured to:
determine that a non-existence area of the target path where no object exists either the left side or the right side is the low possibility area; and
determine that the vehicle travels in the high possibility area during a time period from an entry time point to a satisfaction time point,
the entry time point is a time point when the vehicle enters the non-existence area from the area that is surrounded by the inhibiting objects,
the satisfaction time point is a time point when a predetermined release condition is satisfied.

4. The speed limit control apparatus according to claim 3,
wherein,
the controller is configured to determine that the release condition is satisfied when a travel distance from the entry time point is equal to or longer than a predetermined distance.

5. The speed limit control apparatus according to claim 1,
wherein,
the controller is configured to execute a steering control for controlling steered wheels of the vehicle such that the vehicle travels along the target path.
